(19) United States
(12) Patent Application Publication
(10) Pub. No.: US 2025/0218125 A1
(43) Pub. Date: Jul. 3, 2025

(54) VIRTUAL SPACE PROVISION SYSTEM

(71) Applicant: NTT DOCOMO, INC., Tokyo (JP)

(72) Inventor: Takafumi YAMAZOE, Chiyoda-ku (JP)

(73) Assignee: NTT DOCOMO, INC., Tokyo (JP)

(21) Appl. No.: 18/875,944

(22) PCT Filed: Jul. 31, 2023
(86) PCT No.: PCT/JP2023/027980

§ 371 Date: Dec. 17, 2024

(30) Foreign Application Priority Data
Aug. 4, 2022 (JP) 2022-124694

(51) Int. Cl. G06T 19/00; G06F 3/01; G06T 15/10

(52) U.S. Cl. CPC G06T 19/00; G06F 3/011; G06T 15/10; G06T 2219/024

(57) ABSTRACT

A server is a virtual space provision system that outputs an image generated based on a virtual space where a virtual camera is provided to a plurality of clients, and includes: an association determination unit configured to associate each of the clients with either a first camera, at least one of the position or direction of which corresponds to an operation from the client, or a second camera, the position and direction of which are independent of the operation from the client, based on the number of clients detected by a detection unit; a rendering unit configured to generate an image of the virtual space seen from the first camera or the second camera; and an output unit configured to output the image generated by the rendering unit to the client based on the association by the association determination unit.

### TECHNICAL FIELD

The present invention relates to a virtual space provision system is that outputs an image of a virtual space seen from a virtual camera provided in the virtual space to a plurality of terminals.

### BACKGROUND ART

Conventionally, a virtual space provision system configured to output an image of a virtual space seen from a virtual camera provided in the virtual space to a plurality of terminals has been proposed. For example, Patent Literature 1 describes dividing player objects into groups and arranging a common virtual camera for each group and arranging individual virtual cameras for player objects that do not belong to any group. In this virtual space provision system, images of the virtual space are generated from the common virtual camera and the individual virtual cameras, and the images are provided to the terminals.

### CITATION LIST

### Patent Literature

Patent Literature 1: International Publication WO 2015/011741

### SUMMARY OF INVENTION

### Technical Problem

Here, in the virtual space provision system described in Patent Literature 1, if the number of individual virtual cameras becomes too large, an extremely high processing load is placed on the virtual space provision system when generating images to be provided to the plurality of terminals. For example, each individual virtual camera generates an image of the virtual space seen from the individual virtual camera, and controls the position, direction, and the like of each individual virtual camera in response to input from the user. Here, if the number of individual virtual cameras becomes too large, an extremely high processing load is placed on the virtual space provision system due to the generation of images in the individual virtual cameras and the control of the positions and directions of the individual virtual cameras.

On the other hand, convenience for users assigned to the common virtual camera is greatly lowered. For example, since the common virtual camera is controlled in response to input from a plurality of users, each user cannot necessarily visually recognize the position and direction that the user desires to visually recognize in the virtual space.

An embodiment of the present invention has been made in view of the above, and it is an object thereof to provide a virtual space provision system that can suppress a lowering in user convenience and can reduce the processing load.

### Solution to Problem

In order to achieve the aforementioned object, a virtual space provision system according to one embodiment of the present invention is a virtual space provision system that outputs an image generated based on a virtual space where a virtual camera is provided to a plurality of terminals, and includes: a detection unit configured to detect the number of the plurality of terminals; an association determination unit configured to associate each of the terminals with either a first camera, which is the virtual camera at least one of a position or a direction of which corresponds to an operation from the terminal, or a second camera, which is the virtual camera whose position and direction are independent of the operation from the terminal, based on the number of the terminals detected by the detection unit; a generation unit configured to generate an image of the virtual space seen from at least one of the first camera or the second camera; and an output unit configured to output the image generated by the generation unit to the terminal based on the association by the association determination unit.

In the virtual space provision system according to one embodiment of the present invention, each terminal is associated with either the first camera or the second camera based on the number of the plurality of terminals. For example, when the number of users using the virtual space is small, a terminal is associated with each first camera. Therefore, since at least one of the position or direction of the first camera corresponds to an operation from the terminal, each user can control the position and direction of the first camera through the terminal. As a result, it is possible to improve convenience for each user. In addition, for example, when the number of users using the virtual space is significantly increasing, a plurality of terminals are associated with the second camera. Therefore, it is possible to cancel the control of the virtual camera by the user and reduce the number of virtual cameras. As a result, it is possible to reduce the processing load in the virtual space provision system. From the above, it is possible to suppress a lowering in user convenience and reduce the processing load.

### Advantageous Effects of Invention

It is possible to suppress a lowering in user convenience and reduce the processing load.

### BRIEF DESCRIPTION OF DRAWINGS

FIG. 1 is a block diagram showing the functional configuration of an information processing system including a virtual space provision system according to the present embodiment.

FIG. 2 is a diagram showing an example of a virtual space provided by the virtual space provision system.

FIG. 3 is a diagram showing an example of an image of the virtual space seen from a virtual camera provided in the virtual space in FIG. 2.

FIG. 4 is a flowchart showing a process performed in the virtual space provision system according to an embodiment of the present invention.

FIG. 5 is a diagram showing the hardware configuration of a server that is a virtual space provision system according to the embodiment of the present invention.

### DESCRIPTION OF EMBODIMENTS

Hereinafter, an embodiment of a virtual space provision system according to the present invention will be described in detail with reference to the diagrams. In addition, in the description of the diagrams, the same elements are denoted by the same reference numerals, and repeated description thereof will be omitted.

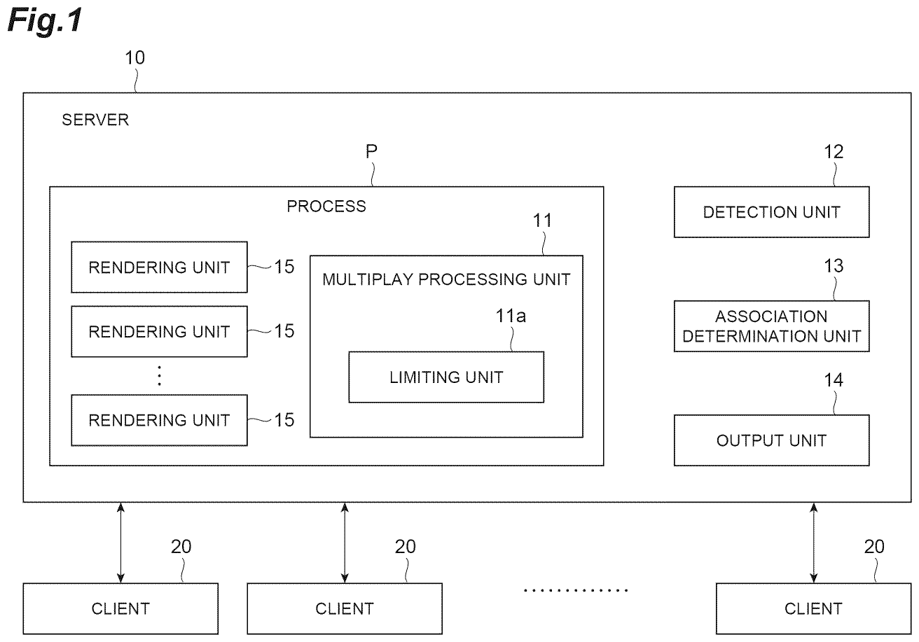

FIG. 1 shows a server (virtual space provision system) 10 according to the present embodiment. The server 10 is connected to a plurality of clients (terminals) 20 so as to be able to transmit and receive information therebetween. The server 10 generates an image based on the virtual space. The server 10 outputs the generated images to the plurality of clients 20. The image generated by the server 10 is an image of the virtual space seen from a virtual camera provided in the virtual space (details will be described later). The server 10 is a system for realizing services related to the virtual space in which a large number of users participate. The server 10 is, for example, a system for realizing cloud gaming, virtual live performance, and the like.

The virtual space is, for example, a virtual three-dimensional space shared between a plurality of users. The virtual space is, for example, a space used for cloud gaming and virtual live performance. The virtual space in the present embodiment is a three-dimensional virtual space. The virtual space does not have to be three-dimensional.

Each user can operate a character in the virtual space through each client 20 as follows. Specifically, first, objects are arranged in the virtual space. Object are structures arranged in the virtual space. Object are, for example, human-like characters that appear in a 3D game provided by the cloud gaming described above. Objects are, for example, buildings and cars. In the virtual space, a user position is set at a predetermined coordinate. The user position is a position corresponding to each client 20 in the virtual space. The user position is, for example, a position where a character that is the user's avatar is arranged. The character arranged at the user position can move within the virtual space by being controlled based on an operation signal input from the client 20.

In addition, each user can visually recognize the inside of the virtual space through each client 20. Specifically, first, a plurality of virtual cameras are arranged in the virtual space. An image of the virtual space seen from the virtual camera is transmitted to the client 20. In the client 20, the user visually recognizes the inside of the virtual space by visually recognizing an image of the virtual space seen from the virtual camera.

The server 10 is, for example, a computer such as a server device. The server 10 may include a plurality of computers. For example, the server 10 may have a plurality of functions as will be described below, or may include a device for each function. The server 10 and the client 20 have a communication function. The server 10 and the client 20 are connected to each other through a communication network so as to be able to transmit and receive information therebetween. The server 10 is, for example, a server capable of providing services related to cloud gaming. As an example, the server 10 is a server having an application (game engine) with a conventional client gaming function.

The server 10 manages the virtual space. The server 10 controls each user position in the virtual space. The server 10 arranges a virtual camera in a virtual space R. The server 10 controls the position and direction of each virtual camera. The server 10 generates a scene captured by the virtual camera in the virtual space as an image of the virtual space seen from the virtual camera. The server 10 performs control so that the image of the virtual space seen from the virtual camera is displayed on the client 20.

The client 20 is a user terminal. The client 20 includes an image output device (for example, a display), a voice input device (for example, a microphone), and a voice output device (for example, a speaker). The client 20 is, for example, a personal computer (PC), a smartphone, a tablet terminal, or an XR (Cross Reality) terminal used by the user. The XR terminal is, for example, a terminal such as VR (Virtual Reality) glasses.

The client 20 is connected to the server 10 so as to be able to transmit and receive information therebetween. In this case, a communication path is formed between the server 10 and the client 20. The client 20 receives a user's operation for operating at least one of the user position or the virtual camera in the virtual space. The client 20 transmits an operation signal indicating the received user's operation to the server 10 through the communication path. The client 20 receives an image of the virtual space seen from the virtual camera from the server 10 through the communication path, and presents the image to the user. In addition, the client 20 receives information indicating a sound in the virtual space from the server 10 through the communication path, and outputs the information to a speaker or the like of the client 20. In addition, when it is possible to reproduce sound at the user position in the virtual space, the client 20 may receive the input of sound through a microphone or the like, and transmit sound data based on the received input to the server 10 through the communication path.

Next, the functions of the server 10 according to the present embodiment will be described, and information processing in the present embodiment will be described in detail.

As shown in FIG. 1, the server 10 includes a detection unit 12, an association determination unit 13, and an output unit 14. The server 10 performs a process P for controlling the virtual space, objects in the virtual space, and virtual cameras. In the process P, the server 10 includes a multiplay processing unit 11 that manages a virtual space, and a plurality of rendering units 15.

The multiplay processing unit 11 performs processing related to multiplay in the virtual space. First, the multiplay processing unit 11 stores data to be used for rendering the virtual space in advance. The multiplay processing unit 11 generates a virtual space using the stored data. More specifically, when the virtual space is used for a 3D action game, the multiplay processing unit 11 stores 3D data (real data), such as a plurality of objects including the user's character in the virtual space and a map showing the virtual space, in advance. In addition, for example, the multiplay processing unit 11 stores in advance a sound source (sound resource) for generating sounds to be output in the virtual space. The multiplay processing unit 11 generates a virtual space using the above-described 3D data. The virtual space is, for example, a virtual space to which a plurality of users are connected (a multiplayer entity). The multiplay processing unit 11 performs physical calculations related to the movement of objects in the virtual space. In addition, the multiplay processing unit 11 may arrange virtual speakers and virtual microphones in the virtual space. The multiplay processing unit 11 may generate sounds generated from objects in the virtual space and reproduce the sounds in the virtual speakers arranged in the virtual space. The multiplay processing unit 11 may acquire sound data from the client 20 and reproduce the sounds based on the sound data in virtual speakers arranged in the virtual space. In addition, the multiplay processing unit 11 may transmit the sounds recorded by the virtual microphones in the virtual space to the client 20 as recorded data. In this case, the recorded data may be reproduced on the speaker of the client 20. In addition, the generation of the virtual space and the physical calculation related to the movement of objects described above can be realized by various methods and configurations using known techniques.

The multiplay processing unit 11 acquires from the client 20 an operation signal for operating at least one of the user position or the virtual camera in the virtual space. The multiplay processing unit 11 controls the user position in the virtual space based on the operation signal transmitted from the client 20. For example, the multiplay processing unit 11 changes the user position based on the acquired operation signal so that the user position corresponds to the user's operation in real time. In addition, the control of the user position in the virtual space described above can be realized by various methods and configurations using known techniques.

The multiplay processing unit 11 arranges two types of virtual cameras, a first camera and a second camera, in the virtual space, and controls the position and direction of each virtual camera. The rendering unit 15 generates an image of the virtual space seen from the virtual camera. In other words, the rendering unit 15 generates an image captured in the virtual space by the virtual camera. The first camera is a virtual camera whose at least one of the position or the direction corresponds to an operation from the client 20. The second camera is a virtual camera whose position and direction are independent of the operation from the client 20.

Specifically, the multiplay processing unit 11 arranges the first camera in the virtual space, and controls at least one of the position or direction of the first camera based on an operation signal input from the client 20. More specifically, when the client 20 is associated with the first camera, the multiplay processing unit 11 arranges a new first camera in the virtual space so as to correspond to the user position corresponding to the client 20. The position and direction of the first camera are controlled to follow the movement of the user position. Such a first camera is a free viewpoint camera. In addition, at least one of the position or direction of the first camera may be controlled by the user independently of the movement of the user position. In addition, the first camera may be arranged in the virtual space in advance. Although the first camera is arranged by the multiplay processing unit 11, the present invention is not limited thereto. For example, the first camera may be arranged by an administrator of the server 10. The control of the position and direction of the first camera can be realized by various methods and configurations using known techniques.

More specifically, the multiplay processing unit 11 arranges a second camera in the virtual space, and controls the position and direction of the second camera. More specifically, the multiplay processing unit 11 may arrange the second camera in advance, or may arrange a new second camera as necessary. The multiplay processing unit 11 controls the position and direction of the second camera independently of the operation from the client 20. Such a second camera is, for example, a fixed camera. The control of the position and direction of the second camera can be realized by various methods and configurations using known techniques.

The images of the virtual space seen from the first and second cameras are scenes seen from a reference position in the virtual space. The reference position corresponding to the first camera may be, for example, the eye position of the user's character in the virtual space or a position around the character. As an example, the reference position is the eye position of a human-like character (first person viewpoint). As another example, the reference position may be a position looking down on a human-like character (third person viewpoint). In addition, the reference position corresponding to the second camera is, for example, a position that is fixed in the virtual space and looks down on the user's character in the virtual space.

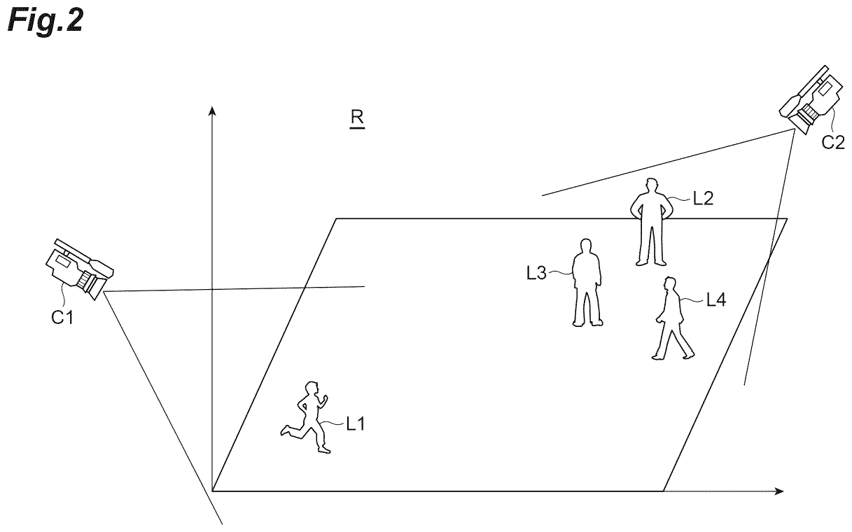

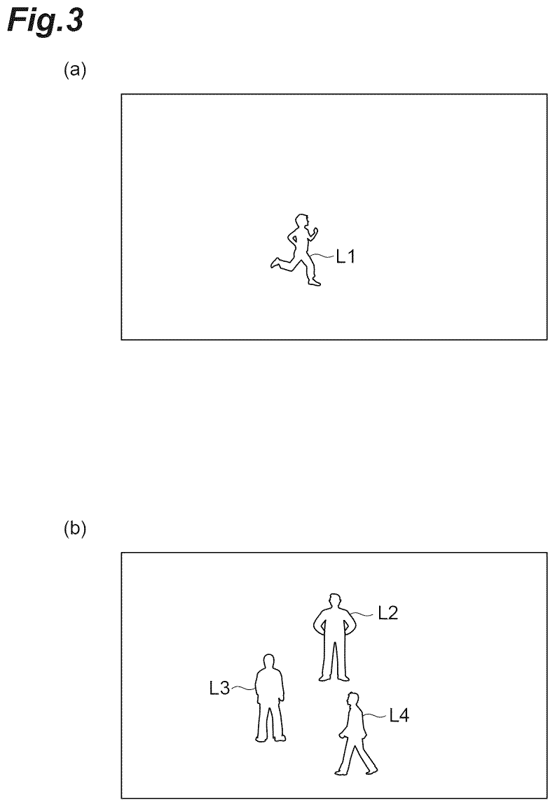

FIG. 2 is a diagram showing a virtual space and virtual cameras arranged in the virtual space. In the example shown in FIG. 2, a first camera C1 is arranged corresponding to a user position L1 in the virtual space R. FIG. 3 (a) is a diagram showing an image of the virtual space R seen from the first camera C1 in FIG. 2. As shown in FIG. 3 (a), the image of the virtual space R seen from the first camera C1 is a scene looking down on the character from a reference position in the virtual space R, with a position set in advance for the character as the reference position. In addition, in the example shown in FIG. 2, a second camera C2 is provided in the virtual space R. FIG. 3 (b) is a diagram showing an image of the virtual space R seen from the second camera C2 in FIG. 2. In the example shown in FIG. 3 (b), the image of the virtual space R seen from the second camera C2 includes user positions L2, L3, and L4.

The detection unit 12 configured to detect the number of clients 20. The number of clients 20 detected by the detection unit 12 is the number of clients 20 currently connected to the server 10 to use the virtual space. For example, the detection unit 12 detects, as the number of clients 20, the number of communication paths established between the client 20 and the server 10 at the time of detection. The detection unit 12 acquires (detects) the user position in the virtual space corresponding to each client 20 from the multiplay processing unit 11.

The detection unit 12 detects a group including a plurality of clients 20. The group is a group to which a plurality of users belong. The group is, for example, a party or a team in a 3D game in which a plurality of users participate. The party is set in advance by the multiplay processing unit 11, the client 20, or the like. The detection unit 12 acquire information indicating the clients 20 corresponding to the users who belong to the group from the multiplay processing unit 11, thereby detecting the group and the clients 20 corresponding to the group. As an example, when users form a group in the virtual space, information indicating the group and the clients 20 corresponding to the users who belong to the group are stored in the server 10. The detection unit 12 acquires the stored information, and detects groups having a number of users set in advance (for example, five users) or more and the clients 20 corresponding to the users who belong to the groups. In addition, the minimum value (the above-described number set in advance) of the number of persons of the groups detected by the detection unit 12 may be increased as the number of clients 20 increases. That is, as the number of users of the virtual space increases, the restrictions on the size of the group detected by the detection unit 12 become stricter.

In addition, for example, the detection unit 12 detects communications between a plurality of users corresponding to the plurality of clients 20, and detects the plurality of clients 20 corresponding to the communications as one group. As an example, the communication is voice chat. The detection unit 12 acquires information about a voice chat in which a plurality of users participate from another server (not shown) used for the voice chat. Based on the acquired information, the detection unit 12 detects a plurality of clients 20 connected to the voice chat as one group. As another example, the communication may be a user's speech in the virtual space. When a user speaks in the virtual space, the detection unit 12 detects a plurality of other user positions located within a predetermined distance from the user position. The detection unit 12 detects, as one group, a plurality of clients 20 corresponding to the user position and the plurality of other user positions detected. In addition, the communication may be an interaction between users using means of communication other than voice.

Based on the number of clients 20 detected by the detection unit 12, the association determination unit 13 associates each of the clients 20 with either the first camera or the second camera. Specifically, the association determination unit 13 compares the number of clients 20 detected by the detection unit 12 with a threshold value set in advance. Based on the result of the comparison, the association determination unit 13 associates each of the clients 20 with either the first camera or the second camera.

More specifically, when the number of clients 20 detected by the detection unit 12 is less than the threshold value set in advance, the association determination unit 13 may associate each of the clients 20 with either the first camera or the second camera. When the number of clients 20 detected by the detection unit 12 is equal to or greater than the threshold value set in advance, the association determination unit 13 associates the clients 20 with only the second camera. At this time, the association determination unit 13 associates the second camera capable of imaging the user positions corresponding to the clients 20 with the clients 20. The second camera capable of imaging a predetermined position can be specified by various methods and configurations using known techniques. In addition, the association determination unit 13 may associate the second camera with the clients 20 in a manner other than that described above. For example, the association determination unit 13 may associate the second camera that is closest to the user position corresponding to the client 20 with the client 20. The threshold value may be set in advance. For example, the threshold value may be set in advance by an administrator of the server 10, or may be set in advance by the server 10 itself in consideration of the processing performance of the server 10.

As an example, when the number of users using the virtual space is less than a threshold value (there is room for more users), the association determination unit 13 prepares first cameras as many as the number of clients 20 detected by the detection unit 12, and associates each of the first cameras with the client 20 one by one. In this case, the first camera is a virtual camera with a free viewpoint that can be operated by the user, and is a virtual camera that can be occupied by a single user. That is, in the server 10, when there is room for more users in the virtual space, the virtual camera associated with each user is used as a free viewpoint camera whose position and direction can be operated by the user. The position and direction of this virtual camera are controlled to follow the user position. In addition, the image of the virtual space seen from this virtual camera may be an image of the virtual space seen from the first person viewpoint or may be an image of the virtual space seen from the third person viewpoint. Here, there may be a case where the number of users using the virtual space increases and the association determination unit 13 cannot prepare the first cameras for all of the users. Thus, when the number of users using the virtual space is equal to or greater than the threshold value, the association determination unit 13 associates all of the clients 20 with any of the plurality of second cameras as described above.

The association determination unit 13 configured to associate one second camera with a plurality of clients 20 included in the group detected by the detection unit 12. Specifically, the association determination unit 13 outputs information indicating a plurality of clients 20 included in the group detected by the detection unit 12 to the multiplay processing unit 11. The multiplay processing unit 11 acquires a plurality of user positions corresponding to the plurality of clients 20 based on the information indicating the plurality of clients 20 included in the group, and arranges one second camera so as to correspond to the plurality of user positions. For example, the multiplay processing unit 11 arranges the second camera so that all of the plurality of user positions are reflected in an image of the virtual space seen from the second camera. The association determination unit 13 associates the plurality of clients 20 included in the group with the second camera arranged by the multiplay processing unit 11. In addition, the above process may be performed with priority over the process based on the number of clients 20 detected by the detection unit 12, but the present invention is not limited thereto. For example, when the number of clients 20 detected by the detection unit 12 is equal to or greater than a threshold value, the association determination unit 13 may associate the second camera with the group. In this case, convenience for users who belong to the group is improved. In addition, for example, even if the number of clients 20 detected by the detection unit 12 is less than the threshold value, the association determination unit 13 may associate the second camera with the group. In this case, since the plurality of clients 20 corresponding to a plurality of users are associated with the second camera, the total number of virtual cameras is reduced, and accordingly, the processing load of the server 10 is reduced.

When associating a plurality of clients 20 included in a group with one second camera, if the user position corresponding to the client 20 moves outside a predetermined range, the association determination unit 13 associates the client 20 with another second camera. The predetermined range is, for example, a range captured in an image of the virtual space seen from the second camera (individually assigned virtual camera) corresponding to the group. For example, the association determination unit 13 switches the virtual camera corresponding to the client 20 from the second camera (individually assigned virtual camera) corresponding to the group to another second camera. That is, the image visually recognized by the user through the client 20 transitions from the image of the virtual space seen from the second camera corresponding to the group (viewpoint of the second camera) to the image of the virtual space seen from another second camera (viewpoint of another second camera). In addition, when one second camera is associated with a plurality of clients 20 included in a group by the association determination unit 13, the range in which the user positions corresponding to the clients 20 included in the group can move may be restricted to a predetermined distance (width) by the multiplay processing unit 11. As an example, the user position may be movable within a range that is captured in the image of the virtual space seen from the second camera. Thus, the user positions corresponding to the clients 20 included in the group are assigned the second camera instead of having their movements restricted. In addition, when a plurality of clients 20 corresponding to the communication is detected as one group by the detection unit 12, the association determination unit 13 assigns the second camera to the plurality of users participating in the communication.

Also based on the user positions of the clients 20 detected by the detection unit 12, the association determination unit 13 associates each of the clients 20 with either the first camera or the second camera. Specifically, the association determination unit 13 associates the client 20 corresponding to the user position with either the first camera or the second camera, based on an area where there is the user position in the virtual space.

As an example, the multiplay processing unit 11 sets an area in the virtual space, which is not captured in the image of the virtual space seen from the second camera, as a blind spot area. When the detection unit 12 detects that the user position is in the blind spot area, the association determination unit 13 notifies the multiplay processing unit 11 of the fact. When the notification is received, the multiplay processing unit 11 arranges a first camera capable of imaging the blind spot area in the virtual space. The association determination unit 13 associates the client 20 corresponding to the user position with the first camera. In addition, the blind spot area may be set in advance. For example, the blind spot area may be set in advance by the administrator of the server 10, or may be set using a method other than the above. In addition, the determination of an area in the virtual space that is not captured in the image of the virtual space seen from the second camera can be realized by various methods and configurations using known techniques. In addition, the above process may be performed with priority over a process based on a threshold value regarding the number of clients 20 detected by the detection unit 12. For example, when the number of clients 20 detected by the detection unit 12 is equal to or greater than a threshold value, the association determination unit 13 may associate the client 20 corresponding to the user position present in the blind spot area with a first camera capable of imaging the blind spot area. In this case, since the image transmitted to the client 20 can maintain the state in which the user position corresponding to the client 20 is shown, it is possible to improve user convenience.

As another example, the administrator of the server 10 or the like fixes the position of the first camera in the virtual space in advance, and arranges the first camera in such a manner that only the direction of the first camera can be operated by the user. When a user position within a predetermined distance from the first camera is detected by the detection unit 12, the association determination unit 13 associates the client 20 corresponding to the user position with the first camera. For example, the administrator of the server 10 or the like arranges a telescope in the virtual space in advance. In this case, when a user position that has been approached within a predetermined distance from the telescope is detected by the detection unit 12, the association determination unit 13 associates the client 20 corresponding to the user position with the telescope. In addition, the above process may be performed with priority over the process based on the number of clients 20 detected by the detection unit 12, but the present invention is not limited thereto. For example, the number of user positions that can be approached within a predetermined distance may be limited by a limiting unit 11a, which will be described later, based on the number of clients detected by the detection unit 12. As an example, the telescope can be used by only one person at a time.

As still another example, the association determination unit 13 associates a first camera with the client 20 corresponding to a user position, which is located in a predetermined area set in advance, in the virtual space, and associates a second camera to the client 20 corresponding to a user position, which is located in another area, in the virtual space. For example, when the virtual space is a VR concert hall or stadium in which a large number of users participate, many users often gather in front of the stage in the live venue to watch a live performance taking place on the stage. Therefore, when a user position in an area in front of the stage and in an area close to the stage is detected by the detection unit 12, the association determination unit 13 associates a second camera (fixed camera) that can be shared by many people with the client 20 corresponding to the user position. The second camera is provided at a position where the stage can be imaged. On the other hand, when a user position in an area where users do not gather (an uncrowded area), such as an area away from the stage (a place behind a live venue), is detected by the detection unit 12, the association determination unit 13 associates the first camera (free viewpoint camera) with the client 20 corresponding to the user position.

In addition, the above process may be performed with priority over the process based on the number of clients 20 detected by the detection unit 12, but the present invention is not limited thereto. For example, an area where a first camera is associated with the client 20 corresponding to a user position (hereinafter, referred to as an area with which the first camera is associated) and an area where a second camera is associated with the client 20 corresponding to a user position (hereinafter, referred to as an area with which the second camera is associated) may be set based on the number of clients 20 (the number of participants) detected by the detection unit 12. For example, the greater the number of clients 20, the larger the area with which the second camera is associated may be set. The smaller the number of clients 20, the larger the area with which the first camera is associated may be set. That is, the range of free viewpoints (free angles) may be controlled depending on the number of participants.

The limiting unit 11a of the multiplay processing unit 11 limits the number of user positions, which are located in a predetermined area set in advance in the virtual space, to a predetermined number or less, based on the number of clients 20 detected by the detection unit 12. Specifically, when the number of users using the virtual space (the number of users) is equal to or greater than a predetermined threshold value, the limiting unit 11a limits the number of user positions located in a predetermined area in the virtual space.

For example, when the number of clients 20 detected by the detection unit 12 increases, the limiting unit 11a limits the number of user positions that can exist simultaneously in a predetermined area included in the virtual space to a predetermined number or less. As an example, the limiting unit 11a may set a predetermined area where the number of characters (hereinafter, referred to as PC (Player Character)) operated by the user in advance. When the number of clients 20 detected by the detection unit 12 increases to exceed a threshold value, the limiting unit 11a prevents other PCs from entering the area if the number of PCs located in the area reaches a predetermined number. At this time, the limiting unit 11a prevents the entry of the PC in a manner that is not uncomfortable for the user (in a natural way). For example, the limiting unit 11a arranges an object and an NPC (Non Player Character) at the entrance of the area. In addition, the limiting unit 11a may set the object and the NPC so that the PC cannot pass through the entrance to a predetermined area, or may set the object and the NPC so that the PC can escape from the predetermined area but cannot enter the predetermined area. In addition, the threshold value may be set in advance. For example, the threshold value may be set in advance by the administrator of the server 10, or may be set in advance by the server 10 itself in consideration of the processing performance of the server 10.

The predetermined area described above may be, for example, the blind spot area described above, or may be an area where the first camera is arranged in advance (the area around the telescope described above). The predetermined number may be set in advance by the limiting unit 11a, or may be set in advance by the administrator of the server 10 or the like. As an example, when the above-described area is a blind spot area or an area where the first camera is arranged, the predetermined number may be set in consideration of the number of clients 20, the processing capacity of the server 10, and the like. For example, when the above-described area is the blind spot area described above, the number of PCs that can simultaneously exist (enter) in the blind spot area is set to ten people by setting the predetermined number to ten people. Here, when the number of clients 20 detected by the detection unit 12 increases, the number of PCs that can simultaneously exist in the blind spot area may be set to five people by setting the predetermined number to five people. In this manner, when the processing load of the server 10 increases, the number of first cameras arranged corresponding to the characters located in the blind spot area decreases. As a result, it is possible to reduce the processing load of the server 10.

A plurality of rendering units (generation units) 15 configured to generate an image of the virtual space seen from at least one of the first camera or the second camera. Specifically, in the process P, a plurality of rendering units 15 are provided for each virtual camera. When a virtual camera is newly arranged, a new rendering unit 15 is provided in the process P. Each rendering unit 15 generates an image of the virtual space seen from the first camera or the second camera arranged in the virtual space by rendering (performs an internal rendering process). Each rendering unit 15 outputs the generated image and information indicating the virtual camera corresponding to itself to the output unit 14. In addition, the process of rendering an image of the virtual space seen from the virtual camera described above can be realized by various methods and configurations using known techniques.

Each rendering unit 15 may generate an image while lowering the quality of the image of the virtual space seen from the first camera based on the number of clients 20 detected by the detection unit 12. Specifically, each rendering unit 15 may lower the quality of the image of the virtual space seen from the first camera when the number of clients 20 detected by the detection unit 12 is equal to or greater than a threshold value. For example, when the user position is in the blind spot area of the second camera, the association determination unit 13 arranges a first camera capable of imaging the blind spot area and controls the first camera by associating the first camera with the client 20. At this time, if the number of clients 20 detected by the detection unit 12 is equal to or greater than the threshold value (when the number of users increases), the processing load of the server 10 becomes too large. In such a case, each rendering unit 15 may lower the quality of the image of the virtual space seen from the first camera arranged in the virtual space (the quality of the free-angle drawing process). This reduces the processing load of the server 10. As a result, the virtual space can be used by a larger number of users (the virtual space can be used by many people). Each rendering unit 15 may generate an image after lowering the quality of the image of the virtual space seen from the first camera capable of imaging the blind spot area, for example. The threshold value may be set in advance. For example, the threshold value may be set in advance by the administrator of the server 10, or may be set in advance by the server 10 itself in consideration of the processing performance of the server 10. In addition, the processing in the rendering unit 15 described above may be performed by another server 10 outside the server 10 (may be performed by cloud rendering).

The output unit 14 configured to output the image generated by each rendering unit 15 to the client 20 based on the association made by the association determination unit 13. Specifically, the output unit 14 acquires the image generated by the rendering unit 15. The output unit 14 acquires information indicating the virtual camera corresponding to each rendering unit 15 from the association determination unit 13. The output unit 14 transmits the image to the client 20 that has been associated with the virtual camera by the association determination unit 13. The output unit 14 is, for example, a function of WebRTC (Web Real-Time Communication). When the virtual camera associated with the client 20 is changed by the association determination unit 13, the server 10 newly designates the path of the WebRTC referenced by the client 20 for the client 20 through the communication path (WebRTC data channel) between the server 10 and the client 20.

For example, in the examples shown in FIGS. 2 and 3, the rendering unit 15 generates an image of the virtual space R seen from the first camera C1, and the output unit 14 transmits the generated image to the client 20 corresponding to the user position L1 detected by the detection unit 12. In addition, the rendering unit 15 generates images of the virtual space R seen from the second camera C2, and the output unit 14 transmits the generated images to the clients 20 corresponding to the user positions L2, L3, and L4 detected by the detection unit 12, respectively.

As described above, first, the client 20 connects to the server 10. Then, when the number of clients 20 (the number of users) connected to the server 10 is small, for example, the server 10 prepares the same number of first cameras as the number of clients 20. The image of the virtual space seen from each first camera (camera angle of the first camera) is assigned to each user who uses each client 20. At this time, each user occupies each first camera.

If the number of clients 20 connected to the server 10 (users of the virtual space) increases and the first camera occupied by one user cannot be prepared for all users, the server 10 switches the virtual camera associated with the client 20 used by each user from the first camera to the second camera, for example. That is, the server 10 switches the image to be transmitted to the client 20 from the image of the virtual space seen from the first camera (free viewpoint camera display) to the image of the virtual space seen from the second camera (fixed point camera display).

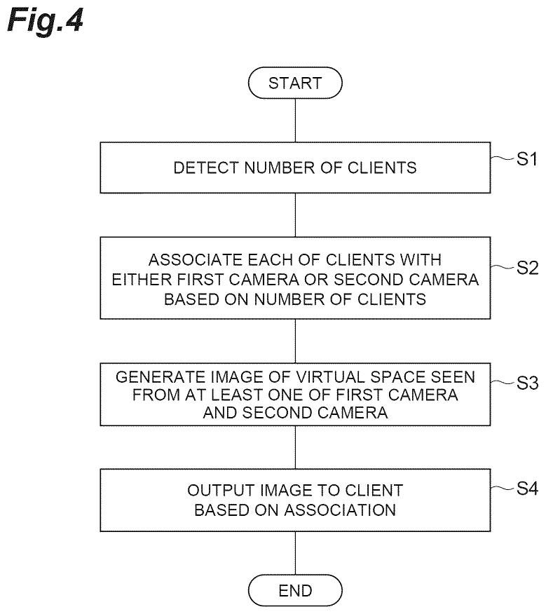

Next, the process performed by the server 10 according to the present embodiment will be described with reference to the flowchart of FIG. 4. In addition, this process is performed when a new client 20 is connected to or disconnected from the server 10. In addition, this process is performed periodically by the server 10.

In this process, first, the number of clients 20 is detected by the detection unit 12 (S01). Then, each of the clients 20 is associated with either the first camera or the second camera by the association determination unit 13 based on the number of clients 20 detected by the detection unit 12 (S02). Then, an image of the virtual space seen from at least one of the first camera or the second camera is generated by each rendering unit 15 (S03). Finally, the image generated by each rendering unit 15 is output to the client 20 by the output unit 14 based on the association made by the association determination unit 13 (S04). This is the process performed by the server 10 according to the present embodiment.

Next, the effects of the server 10 according to the present embodiment will be described. In the virtual space provision system, when a large number of users connect to one virtual space, the processing load increases as the number of users increases, which is an issue.

For example, if the number of virtual cameras operated by the user becomes too large, an extremely high processing load is placed on the virtual space provision system when generating images to be provided to a plurality of clients. For example, a virtual camera operated by the user generates an image of the virtual space seen from the virtual camera, and controls the position, direction, and the like of each virtual camera in response to input from the user. Here, if the number of virtual cameras operated by the user becomes too large, an extremely high processing load is placed on the virtual space provision system due to the generation of images in each virtual camera and the control of the position and direction of the virtual camera operated by the user.

On the other hand, convenience for users assigned to the virtual camera shared between a plurality of users is greatly lowered. For example, since the virtual camera is controlled in response to input from a plurality of users, each user cannot necessarily visually recognize the position and direction that the user desires to visually recognize in the virtual space.

In view of the above, it is desirable to be able to suppress a lowering in user convenience and reduce the processing load.

In the present embodiment, each client 20 is associated with either the first camera or the second camera based on the number of a plurality of clients 20. For example, when the number of users using the virtual space is small, the client 20 is associated with each first camera. Therefore, since at least one of the position or direction of the first camera corresponds to the operation from the client 20, each user can control the position and direction of the first camera through the client 20. As a result, it is possible to improve convenience for each user. In addition, for example, when the number of users using the virtual space is significantly increasing, a plurality of clients 20 are associated with the second camera. Therefore, it is possible to cancel the control of the virtual camera by the user and reduce the number of virtual cameras. As a result, it is possible to reduce the processing load of the server 10. From the above, it is possible to suppress a lowering in user convenience and reduce the processing load of the server 10.

In addition, in the present embodiment, the association determination unit 13 may compare the number of clients 20 detected by the detection unit 12 with a threshold value set in advance and associate each of the clients 20 with either the first camera or the second camera based on the comparison result. According to this configuration, each of the clients 20 is associated with either the first camera or the second camera based on whether the number of the plurality of clients 20 is equal to or greater than a threshold value. For example, when the number of the plurality of clients 20 is equal to or less than the threshold value, the plurality of clients 20 are associated with the first camera. Therefore, when there is room for the processing load of the server 10, each user can control the position and direction of the first camera through the client 20. As a result, it is possible to improve convenience for each user. In addition, for example, when the number of a plurality of clients 20 is equal to or greater than a threshold value, the plurality of clients 20 are associated with the second camera. Therefore, when there is no room for the processing load of the server 10, it is possible to cancel the control of the virtual camera by the user and reduce the number of virtual cameras. However, the association of the client 20 with either the first camera or the second camera does not necessarily have to be performed based on the result of comparing the number of clients 20 with a threshold value.

In addition, in the present embodiment, the detection unit 12 may detect a user position, which is a position corresponding to each of the clients 20 in the virtual space, and the association determination unit 13 may associate each of the clients 20 with either the first camera or the second camera also based on the user position of each of the clients 20 detected by the detection unit 12. As a result, it is possible to associate each of the clients 20 corresponding to the user position with either the first camera or the second camera, in consideration of the characteristics of each location where there is a user position in the virtual space.

As an example, when the user position detected by the detection unit 12 is in a blind spot area, the association determination unit 13 may associate the client 20 corresponding to the user position with a first camera capable of imaging the blind spot area. According to this configuration, when the detection unit 12 detects that the user position operated by the client 20 associated with the second camera has moved into the blind spot area of the second camera, the association determination unit 13 can switch the virtual camera associated with the client 20 from the second camera to the first camera capable of imaging the blind spot area. As a result, since it is possible to maintain a state in which the user position is shown in the image presented to the user on the client 20, convenience for the user can be maintained.

As another example, when the user position detected by the detection unit 12 is within a predetermined distance from the first camera, the association determination unit 13 may associate the client 20 corresponding to the user position with the first camera. Therefore, when the detection unit 12 detects that the user position corresponding to the second camera has approached the location where the first camera is arranged in advance, the association determination unit 13 can associate the client 20 corresponding to the user position with the first camera. For example, when the detection unit 12 detects that the user position has approached a predetermined location, the association determination unit 13 can switch the image transmitted to the client 20 from the image of the virtual space seen from the fixed camera to the image of the virtual space seen from the free viewpoint camera. As a result, when the administrator of the server 10 or the like desires to provide a user with an image seen from the free viewpoint camera at a predetermined location within the area (within the fixed camera area) captured in the image of the virtual space seen from the fixed camera, it is possible to provide the image seen from the free viewpoint camera to a user approaching the predetermined location (the server 10 can transmit an instruction to switch to a free-angle viewpoint to the client 20).

As still another example, the association determination unit 13 may associate a first camera with the client 20 corresponding to the user position detected by the detection unit 12 to be in a predetermined area in the virtual space, and may associate a second camera with the client 20 corresponding to the user position detected by the detection unit 12 to be in another area in the virtual space. Here, if the user visually recognizes the virtual space from the first person viewpoint in an area with a large number of user positions (an area with too many people), the movement of the virtual camera and the visual recognition of the virtual space are obstructed by the other user positions, resulting in poor operability of the virtual camera and poor visibility of the virtual space for the user. In still another example described above, a first camera is associated with the client 20 corresponding to the user position detected by the detection unit 12 to be in an area with a small number of user positions, and a second camera is associated with the client 20 corresponding to the user position detected by the detection unit 12 to be in an area with a large number of user positions. For example, in the area with a large number of user positions, the user can look down on the user positions in the virtual space from above by visually recognizing the image of the virtual space seen from the second camera, which is a fixed camera. As a result, the visibility of the virtual space can be maintained on the user's client 20. In addition, since the user visually recognizes the virtual space from the third person viewpoint, the movement of the virtual camera is suppressed from being obstructed by the other user positions. As a result, it is expected that the user will not feel uncomfortable controlling the virtual camera.

In addition, in the area with a small number of user positions, the user can visually recognize the position and direction that the user desires to visually recognize in the virtual space. As a result, it is possible to improve convenience for the user who visually recognizes the virtual space. In addition, for example, when the user position located in the virtual space moves for the purpose of communicating with other users (other visitors) and participating in a sub-event (experiencing a sub-event) other than the main event in the virtual space, for example, when the user position located in the virtual space moves to an area associated with the second camera (free-angle area), the virtual camera associated with the client 20 corresponding to the user position is switched as described above depending on the area where the user position detected by the detection unit 12 is located. Therefore, it is possible to realize a situation in which a large number of people can use the same virtual space while reducing (controlling) the processing load of the server 10 over the entire virtual space (in total).

However, the association of the client 20 with either the first camera or the second camera does not necessarily have to be performed based on the user position.

In addition, in the present embodiment, the limiting unit 11a may limit the number of user positions located in a predetermined area in the virtual space to a predetermined number or less, based on the number of clients 20 detected by the detection unit 12. Therefore, it is possible to limit the number of user positions located in the area where a load is placed on the server 10 based on the number of clients 20. For example, when the detection unit 12 detects that the user position is in the blind spot area of the second camera, the first camera is associated with the user position. Therefore, the processing load of the server 10 increases. Here, when the number of clients 20 detected by the detection unit 12 is equal to or greater than a predetermined threshold value, the processing load of the server 10 may exceed the limit. At this time, by limiting the number of user positions that can exist in the blind spot area to a predetermined number or less, it is possible to continue to provide the virtual space to the user by suppressing an increase in the processing load of the server 10. However, it is not necessarily necessary to limit the number of user positions located in a predetermined area in the virtual space.

In addition, in the present embodiment, the rendering unit 15 may generate an image after lowering the quality of the image of the virtual space seen from the first camera based on the number of clients 20 detected by the detection unit 12. Therefore, when the number of clients 20 detected by the detection unit 12 increases and there is no room for the processing load of the server 10, it is possible to generate an image after lowering the quality of the image of the virtual space seen from the first camera. As a result, it is possible to suppress an increase in the processing load of the server 10. However, the quality of the image of the virtual space seen from the first camera does not necessarily have to be set based on the number of clients 20 detected by the detection unit 12.

In addition, in the present embodiment, the detection unit 12 may detect a group including a plurality of clients 20, and the association determination unit 13 may associate one second camera with the plurality of clients 20 included in the group detected by the detection unit 12. Since this reduces the total number of virtual cameras compared to a case where each client 20 is associated with one first camera, it is possible to reduce the processing load of the server 10. In addition, since it is possible to newly arrange a first camera in the virtual space by an amount corresponding to the reduction in the processing load of the server 10, it is possible to maximize the number of people who can use the first camera at the same time. In addition, since other users relevant to the user are included in the image transmitted to the client 20 corresponding to the user with priority over other users not relevant to the user, it is possible to improve convenience for the user who uses the client 20. For example, in the image of the virtual space seen from the second camera associated with a plurality of clients 20 included in a group, the user positions of other users belonging to the same group as the user are included with priority over other users who do not belong to the group. As a result, convenience for the user who uses the client 20 that receives the image is improved.

In the present embodiment, the detection unit 12 may detect communications between a plurality of users corresponding to the plurality of clients 20 and detect the plurality of clients 20 corresponding to the communications as one group. For example, when communication such as a voice chat between a plurality of people is detected by the detection unit 12, one second camera is assigned to the members who are communicating. According to this configuration, a plurality of clients 20 participating in one communication are associated with one second camera, and the image of the virtual space seen from the second camera is transmitted to the plurality of clients 20. Therefore, the image transmitted to each client 20 includes the user positions of other users participating in communication together with the user using each client 20. As a result, convenience for the users of the clients 20 is improved.

In addition, in the present embodiment, a plurality of clients 20 can be associated with one second camera. In this case, image rendering can be performed for the plurality of clients 20 by a single process. Therefore, the physical calculations of the movements of objects in the virtual space and the generation of images of the virtual space seen from the virtual camera can be shared between the clients 20 of the users. As a result, it is possible to reduce the processing load of the client 20.

In the present embodiment, a plurality of rendering units 15 are provided in one process P. According to this configuration, the processing in the multiplay processing unit 11 can be shared between a plurality of rendering units 15. Therefore, it is possible to suppress an increase in the processing load of the server 10 when the number of clients 20 (the number of users using the virtual space) increases.

In addition, in the present embodiment, the following configurations may be adopted. These configurations can be realized by known techniques. In the present embodiment, the virtual space provision system includes one server 10 having one process P, but the present invention is not limited thereto. The virtual space provision system may include a plurality of servers 10. In this case, for example, one virtual space is partitioned into a plurality of portions, and each of the plurality of servers 10 is associated with one of the plurality of portions (a plurality of virtual spaces) of the virtual space. In each server 10, a plurality of processes P, which are processes for managing the plurality of portions, are performed. Each multiplay processing unit 11 in one server 10 maintains processing consistency between the processes P. In addition, a multiplay processing server is provided between the servers 10. The multiplay processing server maintains processing consistency between the processes P of different servers 10. In addition, when there are a plurality of multiplay processing servers, a higher-level server (global multiplay server) may be provided to maintain processing consistency between the multiplay processing servers. As described above, the virtual space may be managed by a plurality of processes, a plurality of servers, and a higher-level server. As a result, more users can participate in the virtual space, and even if the scale of the virtual space becomes large, complex communication expressions, physical calculations, and the like can be processed in real time in each process P. In addition, the multiplay processing unit 11 of each process P may function as a server or client for multiplay in a local environment.

In addition, in the present embodiment, the server 10 may include a plurality of servers. The server 10 may have a main server including the multiplay processing unit 11, the detection unit 12, the association determination unit 13, and the rendering unit 15 and a relay server including the output unit 14. The relay server is a server that relays communications between the main server and a plurality of clients 20. The relay server is, for example, a selective forwarding unit (SFU). In the relay server, an image of the virtual space seen from the virtual camera in the virtual space is distributed to each client 20 by WebRTC. In addition, when the image to be transmitted to the client 20 is switched, the following process is performed. First, the association determination unit 13 informs the client 20 of a virtual camera, which is to be associated with the client 20, through the relay server. Then, the client 20 sends a request for the image of the virtual space seen from the designated virtual camera to the relay server. Finally, the output unit 14 of the relay server transmits the image requested from the client 20 to the client 20.

In addition, when the user position moves from a portion of the virtual space managed by the multiplay processing unit 11 of one process to another portion managed by the multiplay processing unit 11 of another process, the image to be output to the client 20 is switched in the output unit 14 of the relay server (WebRTC watching channel is switched). Therefore, even if the user position moves between processes and between servers, the process of switching the image to be output to the client 20 is not delayed in response to the movement.

In addition, in the present embodiment, the multiplay processing unit 11 is provided in the same process P as a plurality of rendering units 15, but it is sufficient if the processing in the multiplay processing unit 11 is shared between the plurality of rendering units 15. For example, the multiplay processing unit 11 may be provided in a process other than the plurality of rendering units 15.

In addition, in the present embodiment, the association determination unit 13 may associate the first camera with the client 20 even if the number of clients 20 detected by the detection unit 12 is equal to or greater than a threshold value. For example, when the number of clients 20 detected by the detection unit 12 is equal to or greater than the threshold value, the association determination unit 13 may associate the first camera with a predetermined number of clients 20 when there is room for the processing load of the server 10 (for example, when an index value indicating the processing load of the server 10 is equal to or less than a predetermined threshold value). As a result, it is possible to improve convenience for each user while taking into consideration the processing load of the server 10.

In addition, in the present embodiment, the association determination unit 13 may associate the first camera with the client 20 of the user who has paid a fee to the provider of the service using the above-described virtual space. In this case, the association determination unit 13 may associate the second camera with the client 20 of the user who does not pay the fee. That is, the user may be able to use a free viewpoint (free angle) camera for a fee, and may also be able to use a fixed camera free of charge. In addition, the server 10 may have a server for a first camera (free angle) in which the rendering unit 15 is provided. In this case, the rendering unit 15 of the server for the first camera generates an image of the virtual space seen from the first camera associated with the client 20 of the user who has paid the fee. In addition, the association determination unit 13 may associate the first camera with the client 20 of the user who has paid something other than the fee. As an example, a user may accumulate points that are linked to the user's account by using a service. In this case, the association determination unit 13 may associate the first camera with the client 20 of the user who has paid the points to the service provider.

The virtual space provision system of the present disclosure has the following configuration.

[1] A virtual space provision system that outputs an image generated based on a virtual space where a virtual camera is provided to a plurality of terminals, including: a detection unit configured to detect the number of the plurality of terminals; an association determination unit configured to associate each of the terminals with either a first camera, which is the virtual camera at least one of a position or a direction of which corresponds to an operation from the terminal, or a second camera, which is the virtual camera whose position and direction are independent of the operation from the terminal, based on the number of the terminals detected by the detection unit; a generation unit configured to generate an image of the virtual space seen from at least one of the first camera or the second camera; and an output unit configured to output the image generated by the generation unit to the terminal based on the association by the association determination unit.

[2] The virtual space provision system according to [1], wherein the association determination unit compares the number of the terminals detected by the detection unit with a threshold value set in advance, and associates each of the terminals with either the first camera or the second camera based on a result of the comparison.

[3] The virtual space provision system according to [1] or [2], wherein the detection unit detects a user position that is a position in the virtual space corresponding to each of the terminals, and the association determination unit associates each of the terminals with either the first camera or the second camera also based on the user position of each of the terminals detected by the detection unit.

[4] The virtual space provision system according to [3], further including: a limiting unit that limits the number of user positions located in a predetermined area in the virtual space to a predetermined number or less based on the number of the terminals detected by the detection unit.

[5] The virtual space provision system according to any one of [1] to [4], wherein the generation unit generates the image after lowering quality of the image of the virtual space seen from the first camera based on the number of the terminals detected by the detection unit.

[6] The virtual space provision system according to any one of [1] to [5], wherein the detection unit detects a group including the plurality of terminals, and the association determination unit associates one second camera with the plurality of terminals included in the group detected by the detection unit.

[7] The virtual space provision system according to [6], wherein the detection unit detects communications between a plurality of users corresponding to the plurality of terminals, and detects the plurality of terminals corresponding to the communications as one group.

The block diagrams used in the description of the above embodiment show blocks in functional units. These functional blocks (configuration units) are realized by any combination of at least one of hardware or software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

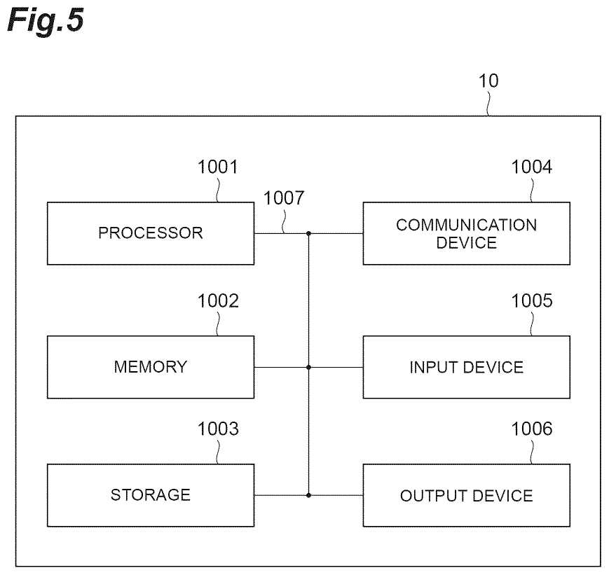

For example, the server 10 according to an embodiment of the present disclosure may function as a computer that performs processing of the wireless communication method according to the present disclosure. FIG. 5 is a diagram showing an example of the hardware configuration of the server 10 according to an embodiment of the present disclosure. The server 10 described above may be physically configured as a computer device including a processor 1001, a memory 1002, a storage 1003, a communication device 1004, an input device 1005, an output device 1006, a bus 1007, and the like. In addition, the client 20 may have the same configuration as hardware described herein.

In addition, in the following description, the term “device” can be read as a circuit, a unit, and the like. The hardware configuration of the server 10 may include one or more devices for each device shown in the diagram, or may not include some devices.

Each function of the server 10 is realized by reading predetermined software (program) onto hardware, such as the processor 1001 and the memory 1002, so that the processor 1001 performs an operation and controlling communication by the communication device 1004 or controlling at least one of reading or writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, each function of the server 10 may be realized by the processor 1001. In addition, the processor 1001 may include a GPU (Graphics Processing Unit). For example, the rendering unit 15 shown in FIG. 1 may be realized by the processor 1001.

In addition, the processor 1001 reads a program (program code), a software module, data, and the like into the memory 1002 from at least one of the storage 1003 or the communication device 1004, and executes various kinds of processing according to these. As the program, a program causing a computer to execute at least a part of the operation described in the above embodiment is used. For example, each function of the server 10 may be implemented by a control program stored in the memory 1002 and operating in the processor 1001, or may be implemented similarly for other functional blocks. Although it has been described that the various kinds of processes described above are performed by one processor 1001, the various kinds of processes described above may be performed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), or a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (registered trademark) disk), a smart card, a flash memory (for example, a card, a stick, a key drive), a floppy (registered trademark) disk, or a magnetic strip. The storage 1003 may be called an auxiliary storage device. The storage medium provided in the server 10 may be, for example, a database including at least one of the memory 1002 or the storage 1003, a server, or other appropriate media.

The communication device 1004 is hardware (transmitting and receiving device) for performing communication between computers through at least one of a wired network or a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the server 10 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented by using at least one of these hardware components.

In the processing procedure, sequence, flowchart, and the like in each aspect/embodiment described in this disclosure, the order may be changed as long as there is no contradiction. For example, for the methods described in the present disclosure, elements of various steps are presented using an exemplary order. However, the present invention is not limited to the specific order presented.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, in a case where software is transmitted from a website, a server, or other remote sources using at least one of the wired technology (coaxial cable, optical fiber cable, twisted pair, digital subscriber line (DSL), and the like) or the wireless technology (infrared, microwave, and the like), at least one of the wired technology or the wireless technology is included within the definition of the transmission medium.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The term “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, accessing (for example, accessing data in a memory) as “determining”. In addition, “determining” can include considering resolving, selecting, choosing, establishing, comparing, and the like as “determining”. In other words, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, or printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, in a case where articles, for example, a, an, and the in English, are added by translation, the present disclosure may include that nouns subsequent to these articles are plural.

### REFERENCE SIGNS LIST

10: server, 11a: limiting unit, 12: detection unit, 13: association determination unit, 14: output unit, 15: rendering unit, 20: client, 1001: processor, 1002: memory, 1003: storage, 1004: communication device, 1005: input device, 1006: output device, R: virtual space, C1: first camera, C2: second camera, L1 to L4: user position.

1. A virtual space provision system that outputs an image generated based on a virtual space where a virtual camera is provided to a plurality of terminals, comprising circuitry configured to:
detect the number of the plurality of terminals:
associate each of the terminals with either a first camera, which is the virtual camera at least one of a position or a direction of which corresponds to an operation from the terminal, or a second camera, which is the virtual camera whose position and direction are independent of the operation from the terminal, based on the number of the detected terminals;
generate an image of the virtual space seen from at least one of the first camera or the second camera; and
output the generated image to the terminal based on the association.

2. The virtual space provision system according to claim 1,
wherein the circuitry compares the detected number of the terminals with a threshold value set in advance, and associates each of the terminals with either the first camera or the second camera based on a result of the comparison.

3. The virtual space provision system according to claim 1,
wherein the circuitry detects a user position that is a position in the virtual space corresponding to each of the terminals, and
associates each of the terminals with either the first camera or the second camera based on the user position of each of the detected terminals.

4. The virtual space provision system according to claim 3,
wherein the circuitry:
limits the number of user positions located in a predetermined area in the virtual space to a predetermined number or less based on the number of the detected terminals.

5. The virtual space provision system according to claim 1,
wherein the circuitry generates the image after lowering quality of the image of the virtual space seen from the first camera based on the number of the detected terminals.

6. The virtual space provision system according to claim 1,
wherein the circuitry detects a group including the plurality of terminals, and
associates the one second camera with the plurality of terminals included in the detected group.

7. The virtual space provision system according to claim 6,
wherein the circuitry detects communications between a plurality of users corresponding to the plurality of terminals, and detects the plurality of terminals corresponding to the communications as the one group.
